(19) United States
(12) Patent Application Publication
(10) Pub. No.: US 2022/0272124 A1
(43) Pub. Date: Aug. 25, 2022

(54) USING MACHINE LEARNING FOR DETECTING SOLICITATION OF PERSONALLY IDENTIFIABLE INFORMATION (PII)

(71) Applicant: Intuit Inc., Mountain View, CA (US)

(72) Inventors: Pawel Piotr Zawadzki, San Mateo, CA (US); Lin Tao, Fremont, CA (US); Sara Julia Katarina Slama, Albany, CA (US)

(73) Assignee: Intuit Inc., Mountain View, CA (US)

(21) Appl. No.: 17/179,799

(22) Filed: Feb. 19, 2021

(51) Int. Cl. H04L 29/06; G06N 3/08; G06N 3/04

(52) U.S. Cl. CPC H04L 63/1483; G06N 3/08; G06N 3/04

(57) ABSTRACT

Systems and methods for identifying solicitations of personally identifiable information (PII) are disclosed. An example method includes generating training data based on historical transcript data corresponding to solicitations of PII in historical support call transcripts, training a neural network, using the training data, to identify solicitations of PII in support call transcripts, and processing the trained neural network for deployment.

### TECHNICAL FIELD

This disclosure relates generally to audio or audio/visual customer support calls, and more particularly to analysis of transcripts of such calls.

### DESCRIPTION OF RELATED ART

Developers of consumer-facing applications increasingly deploy customer support systems enabling a user to engage in a call with an agent, for example, to answer questions the customer may have. Transcripts may be generated from such calls, and various types of information may be determined from analysis of such transcripts. For example, analyzing the transcripts may aid in protecting sensitive user information during such support calls. However, due to the size of such transcripts, and the comparative rarity of some important information found in the transcripts, more efficient transcript analysis is desirable.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for identifying solicitations of personally identifiable information (PII). An example method includes generating training data based on historical transcript data corresponding to solicitations of PII in historical support call transcripts, training a neural network, using the training data, to identify solicitations of PII in support call transcripts, and processing the trained neural network for deployment. In some instances, the PII may be a social security number. In some other instances, the PII may be a credit card number.

In some implementations, the method may also include receiving a support call transcript, and generating a PII solicitation risk score for the received support call transcript using the trained neural network. The method may also include comparing the generated PII solicitation risk score to a threshold risk score, and generating a PII solicitation alert in response to the generated PII solicitation risk score exceeding the threshold risk score. In some instances, the neural network is a feed-forward neural network. In some other instances, the neural network is a multilayer perceptron.

In some implementations, training the neural network includes selecting a smallest model architecture configured to maximize an area under the curve (AUC) of a receiver operating characteristic (ROC) for the training data. In other implementations, training the neural network includes selecting hyperparameters for the neural network based at least in part on Bayesian hyperparameter search. In some implementations, generating the training data includes extracting sentences from the historical transcript data including confirmed solicitations of PII and corresponding responses from the historical transcript data to the sentences including confirmed solicitations of PII.

Another innovative aspect of the subject matter described in this disclosure can be implemented in a system for identifying solicitations of personally identifiable information (PII). An example system includes one or more processors, and a memory storing instructions for execution by the one or more processors. Execution of the instructions causes the system to perform operations including generating training data based on historical transcript data corresponding to solicitations of PII in historical support call transcripts, training a neural network, using the training data, to identify solicitations of PII in support call transcripts, and processing the trained neural network for deployment. In some instances, the PII may be a social security number. In some other instances, the PII may be a credit card number.

In some implementations, execution of the instructions causes the system to perform operations further including receiving a support call transcript, and generating a PII solicitation risk score for the received support call transcript using the trained neural network. Execution of the instructions causes the system to perform operations further including comparing the generated PII solicitation risk score to a threshold risk score, and generating a PII solicitation alert in response to the generated PII solicitation risk score exceeding the threshold risk score. In some instances, the neural network is a feed-forward neural network. In some other instances, the neural network is a multilayer perceptron.

In some implementations, training the neural network includes selecting a smallest model architecture configured to maximize an area under the curve (AUC) of a receiver operating characteristic (ROC) for the training data. In other implementations, training the neural network includes selecting hyperparameters for the neural network based at least in part on Bayesian hyperparameter search. In some implementations, generating the training data includes extracting sentences from the historical transcript data including confirmed solicitations of PII and corresponding responses from the historical transcript data to the sentences including confirmed solicitations of PII.

Another innovative aspect of the subject matter described in this disclosure can be implemented in a system for identifying solicitations of personally identifiable information (PII). An example system includes one or more processors, and a memory storing instructions for execution by the one or more processors. Execution of the instructions causes the system to perform operations including receiving a support call transcript, generating a PII solicitation risk score for the received support call transcript using a neural network trained to identify solicitations of PII in support call transcripts, comparing the generated PII solicitation risk score to a threshold risk score, and in response to the generated PII solicitation risk score exceeding the threshold risk score, generating a PII solicitation alert.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a PII solicitation detection system, according to some implementations.

FIG. 2 shows a high-level overview of an example process flow that may be employed by the PII solicitation detection system of FIG. 1.

FIG. 3 shows an illustrative flow chart depicting an example operation for identifying solicitations of personally identifiable information (PII), according to some implementations.

FIG. 4 shows an illustrative flow chart depicting an example operation for identifying solicitations of personally identifiable information (PII), according to some implementations.

Like numbers reference like elements throughout the drawings and specification.

### DETAILED DESCRIPTION

Implementations of the subject matter described in this disclosure may be used to identify solicitations of personally identifiable information (PII) in transcripts of support calls using one or more trained neural networks. Further, implementations may be used to generate training data for such neural networks and train the neural networks using the generated training data. For example, various implementations disclosed herein may generate such training data from transcripts of historical support calls, such as by isolating and extracting sentences from the transcripts including confirmed solicitations of PII and corresponding responses. The training data may be used for training the one or more neural networks to generate a PII solicitation risk score for an input support call transcript. Identifying solicitations of PII using such trained neural networks may be more efficient and accurate than conventional rules-based systems for identifying solicitations of PII in support call transcripts and may further be substantially more scalable than such conventional solutions, which is important given the increasing numbers of applications and companies providing customer support using agent chat systems. These and other aspects of the example implementations are discussed further below.

Various implementations of the subject matter disclosed herein provide one or more technical solutions to the technical problem of identifying solicitations of PII in a large number of call transcripts. Example implementations may identify solicitations of PII in support call transcripts using one or more neural networks trained using historical support call transcripts. Further, some implementations may further generate the training data from transcripts of historical support calls, such as by isolating and extracting sentences from the transcripts including confirmed solicitations of PII and corresponding responses. Allowing for such trained neural networks to identify solicitations of PII in support call transcripts may increase efficiency and accuracy of systems for reviewing support call transcripts by reducing false-positive rates, allowing such systems to learn over time from subsequently analyzed support call transcripts, and allowing changes to be made to detection systems, as compared to conventional rules-based systems. More specifically, various aspects of the present disclosure provide a unique computing solution to a unique computing problem that did not exist prior to electronic or online user assistance systems that can generate support call transcripts and analyze such transcripts for solicitations of PII. As such, implementations of the subject matter disclosed herein are not an abstract idea such as organizing human activity or a mental process that can be performed in the human mind.

Moreover, various aspects of the present disclosure effect an improvement in the technical field of identifying solicitations of PII in support call transcripts. The use of neural networks, trained based on historical support call transcripts, may allow for more accurate, dynamic, and scalable identification of such solicitations, allowing for more efficient use of computing resources, fewer false positives, and for the system to be more easily updated as compared with conventional rules-based systems. Training a neural network and using such a trained neural network for identifying solicitations of PII in support call transcripts cannot be performed in the human mind, much less using pen and paper. In addition, implementations of the subject matter disclosed herein are usable with a wide variety of computing applications, and do far more than merely create contractual relationships, hedge risks, mitigate settlement risks, and the like, and therefore cannot be considered a fundamental economic practice.

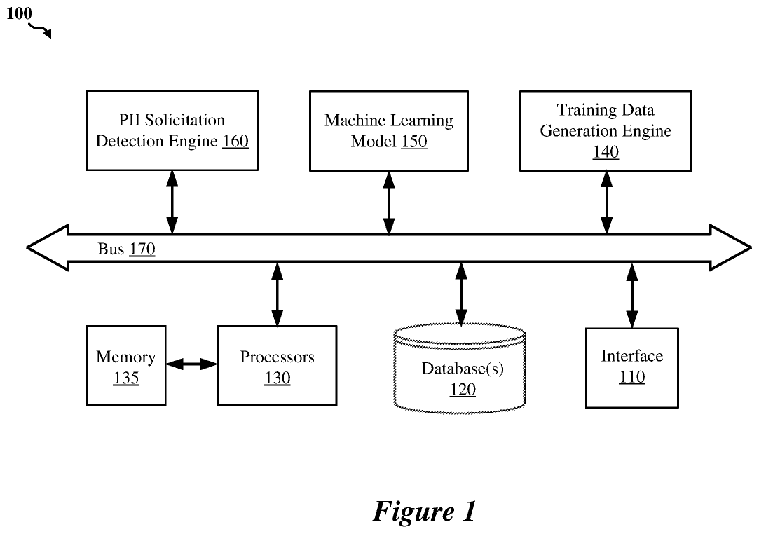

FIG. 1 shows a PII solicitation detection system 100, according to some implementations. Various aspects of the PII solicitation detection system 100 disclosed herein may be applicable for training one or more neural networks to identify solicitations of PII in support call transcripts and to use the trained neural networks to identify solicitations of PII in an input support call transcript in a variety of computing applications. Such functionality may be useful for protecting user privacy and identifying improper solicitation of PII during user support calls in a wide variety of applications, such as entertainment applications, financial applications, audiovisual recording, or streaming applications, and so on. In some aspects, the PII solicitation detection system 100 may be configured to identify solicitations of PII in support call transcripts for users of a single specified computing application, while in some other aspects, the PII solicitation detection system 100 may be configured to identify solicitations of PII in support call transcripts for users of two or more computing applications.

The PII solicitation detection system 100 is shown to include an input/output (I/O) interface 110, a database 120, one or more data processors 130, a memory 135 coupled to the data processors 130, a training data generation engine 140, one or more machine learning models 150, and a PII solicitation detection engine 160. In some implementations, the various components of the PII solicitation detection system 100 may be interconnected by at least a data bus 170, as depicted in the example of FIG. 1. In other implementations, the various components of the PII solicitation detection system 100 may be interconnected using other suitable signal routing resources.

The interface 110 may include a screen, an input device, and other suitable elements that allow a user to provide information to the PII solicitation detection system 100 and/or to retrieve information from the PII solicitation detection system 100. Example information that can be provided to the PII solicitation detection system 100 may include configuration information for the PII solicitation detection system 100, such as information for configuring the training data generation engine 140, training data or a trained machine learning model for the machine learning model 150, historical support call transcripts, or the like. Example information that can be retrieved from the PII solicitation detection system 100 may include PII solicitation risk scores generated by the trained machine learning models 150 or PII solicitation detection engine 160, one or more trained machine learning models, one or more PII solicitation alerts, configuration information for the PII solicitation detection system 100, and the like.

The database 120, which may represent any suitable number of databases, may store any suitable information pertaining to configuration of the PII solicitation detection system 100, to users of the PII solicitation detection system 100. For example, the information may include configuration information for generating training data based on historical support call transcripts using the training data generation engine 140, may include configuration information for the machine learning model 150, and may include historical support call transcripts of historical support calls. In some implementations, the database 120 may be a relational database capable of presenting the information as data sets to a user in tabular form and capable of manipulating the data sets using relational operators. In some aspects, the database 120 may use Structured Query Language (SQL) for querying and maintaining the database 120.

The data processors 130, which may be used for general data processing operations (such as manipulating the data sets stored in the database 120), may be one or more suitable processors capable of executing scripts or instructions of one or more software programs stored in the PII solicitation detection system 100 (such as within the memory 135). The data processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 may be implemented as a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the data processors 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The training data generation engine 140 may generate training data for the machine learning models 150 based on historical support call transcripts. For example, the historical support call transcripts may be retrieved from the database 120, from another memory coupled to the PII solicitation detection system 100, or via one or more networks coupled to the PII solicitation detection system 100. As discussed in more detail below, the training data generation engine 140 may generate training data based on the historical support call transcripts by identifying, extracting, and processing relevant sentences of the historical support call transcripts. In some aspects, the training data generation engine 140 may generate the training data based on extracted sentences from the historical support call transcripts which have been confirmed to include solicitations of PII, in addition to corresponding responses to those sentences. In some aspects, the extracted sentences may be sentence embedded using a suitable sentence encoder, as discussed below.

The machine learning model 150 may include any number of machine learning models that can be trained, using training data from training data generation engine 140, to detect solicitations of PII in an input support call transcript. A machine learning model can take the form of an extensible data structure that can be used to represent sets of words or phrases and/or can be used to represent sets of attributes or features. The machine learning models may be trained with data indicating solicitations of PII extracted from historical support call transcripts. In some implementations, the machine learning models 150 may include deep neural networks (DNNs), which may have any suitable architecture, such as a feedforward architecture or a recurrent architecture. For example, as discussed below, the machine learning model 150 may include a multilayer perceptron model—a type of feedforward neural network.

The PII solicitation detection engine 160 may be used to detect solicitations of PII for input support call transcripts using the trained machine learning model 150. As discussed further below, the PII solicitation detection engine 160 may receive an input support call transcript and generate a PII solicitation risk score using the trained machine learning model 150. This PII solicitation risk score may be used to generate an alert, if the PII solicitation risk score exceeds a threshold risk score. The alert may indicate that an agent participating in a support call transcribed in the input support call transcript is likely to have improperly requested PII from a customer or user also participating in the support call.

The particular architecture of the PII solicitation detection system 100 shown in FIG. 1 is but one example of a variety of different architectures within which aspects of the present disclosure may be implemented. For example, in other implementations, the PII solicitation detection system 100 may not include the training data generation engine 140, the functions of which may be implemented by the processors 130 executing corresponding instructions or scripts stored in the memory 135. In some other implementations, the functions of the machine learning model 150 may be performed by the processors 130 executing corresponding instructions or scripts stored in the memory 135. Similarly, the functions of the PII solicitation detection engine 160 may be performed by the processors 130 executing corresponding instructions or scripts stored in the memory 135.

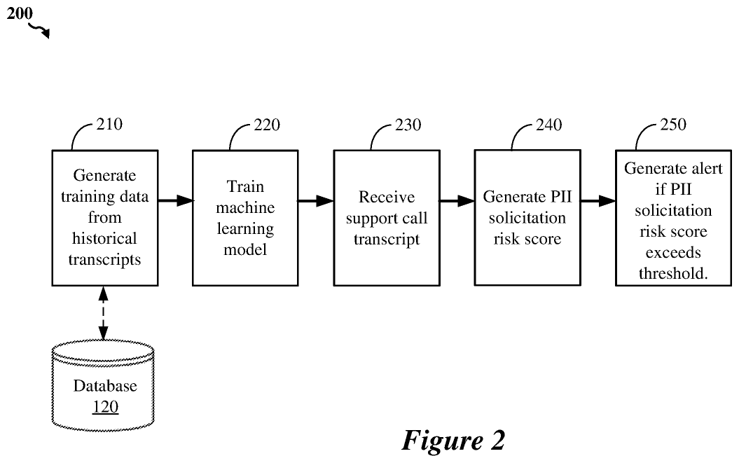

FIG. 2 shows a high-level overview of an example process flow 200 that may be employed by the PII solicitation detection system 100 of FIG. 1. In block 210, the PII solicitation detection system 100 generates training data from historical support call transcripts. For example, the historical support call transcripts may be retrieved from the database 120 or received via one or more network interfaces coupled to the PII solicitation detection system 100. The training data may be generated using training data generation engine 140. In block 220, the machine learning model 150 is trained using the generated training data. For example, the training data may train the machine learning model to detect solicitations of PII in support call transcripts. In block 230, a support call transcript may be received. For example, the support call transcript may be retrieved from the database 120 or received via one or more network interfaces coupled to the PII solicitation detection system 100. In block 240, the trained machine learning model 150 may generate a PII solicitation risk score for the received support call transcript. For example, the PII solicitation detection engine 160 may use the trained machine learning model 150 to generate the PII solicitation risk score, which corresponds to an estimated likelihood that PII was solicited in the received support call transcript. At block 250, the personalized messaging engine 160 may generate a PII solicitation alert if the PII solicitation risk score exceeds a threshold risk score. The generated PII solicitation alert may cause additional review of the received support call transcript, for example the PII solicitation alert may prompt a human review of the transcript to verify whether PII was solicited or whether the generated alert is a false positive.

As discussed above, live chat, audio chat, and audiovisual call systems are increasingly deployed to assist users of various applications with a variety of tasks, such as answering questions, assisting users with tasks in the application, providing other customer support, and so on. Such systems typically have an agent of the application communicating (e.g., speaking or texting) with a customer or user of the application, and a session between an agent and a user may be referred to as a support call. Upon completion, such support calls are generally transcribed, resulting in a support call transcript, which may be used by the application provider for memorializing the call, determining answers to frequently asked questions, and so on. While such systems may be beneficial to users, care must be taken to protect sensitive user information, such as PII. For example, such PII may include social security numbers, credit card numbers, bank account numbers, and other sensitive user information. Identifying improper solicitations of PII may therefore be an important consideration when employing audio and audiovisual support call systems. For example, agents may not be permitted to ask customers for PII during a support call, and it may be important to identify when agents make such an improper request. Such improper requests may be innocent mistakes, or may be malicious—for example, with intent to misuse the PII. Further, privacy laws and policies may require careful treatment of customer's PII. Accordingly, it is important to identify when agents solicit PII within a support call. Conventional systems may apply rule-based systems to support call transcripts in order to identify when PII is solicited. However, such rule-based systems may result in large numbers of false positives—when the rule-based system falsely identifies a solicitation of PII. Rule-based systems may also be static and difficult to update. Finally, rule-based systems may be difficult to scale, which may result in either undesirably large amounts of computing resources required to process support call transcripts or may result in substantial delays in processing support call transcripts when sufficient computing resources are unavailable. This may substantially impact efforts to accurately and efficiently identify solicitations of PII in support calls.

The example implementations allow for identification of solicitations of PII in support call transcripts to be identified more quickly and more accurately, using machine learning rather than conventional rule-based systems. This may reduce the additional review required by the false positives resulting from conventional techniques and limit the delays or computing resources required for conventional techniques. More specifically, the example implementations may train neural networks, such as feedforward neural networks, to identify solicitations of PII in support call transcripts. In some examples the neural network may be a feedforward neural network such as a multilayer perceptron. Further, as discussed below, the example implementations may generate training data for such neural networks based on historical support call transcripts. After processing the trained neural network for deployment, e.g., by regularizing the trained model, and selecting optimal hyperparameters, the model may be deployed. When a support call transcript is input to the trained neural network, a PII solicitation risk score is generated, which may prompt an alert, if the PII solicitation risk score exceeds a threshold.

As discussed above, the example implementations may generate training data for the neural networks based on historical support call transcripts. Because solicitations of PII in support calls may be quite rare, detecting these solicitations may be an imbalanced problem, in that relatively few positive results may be found in a large amount of data. Thus it may be important to carefully select which exchanges are identified as relevant in the training data. It may further be important to tailor the training to each type of PII, that is, a neural network may be trained using different training data to identify solicitations of social security numbers as compared to identifying solicitations of credit card numbers.

In some aspects, relevant exchanges are those in which specified keywords are present in sentences uttered by the agent and followed by a response from the customer. For example, where the PII at issue is a social security number, the specified keywords may include “social,” “social security,” “ssn,” and similar. Similar keywords may be specified for other PII, such as “card,” “credit card,” “visa,” “MasterCard,” or similar for credit card numbers, or “account number,” bank account,” “routing number,” or similar for bank account information. Thus, the relevant agent utterances may be different when training neural networks to identify different types of PII.

Further, in some aspects, relevant exchanges may include those where a sentence including one or more specified keywords uttered by the agent is followed by a response from the customer including a plurality of numbers. Because a variety of types of PII include a plurality of digits, (e.g., social security numbers, credit card numbers, and bank account numbers), then the relevant customer responses may be the same or similar when training neural networks to identify different types of PII.

After identifying the relevant exchanges in the historical support call transcripts, these relevant exchanges may be extracted and encoded for use as training data for the neural networks. Further, in some aspects these exchanges may be labelled as confirmed solicitations of PII or as benign or false positives. For example, a confirmed solicitation may include an agent's improper request of PII, while a benign exchange may not. For example, in a benign exchange the agent may be referring to a social network, or to a customer applying for social security, rather than requesting the customer's social security number. Further, there may be exchanges where an agent properly requests, for example, a final several digits, such as four digits, of a customer's social security or credit card numbers, and such requests may not be improper, and including and properly labeling such exchanges in the training data may help to reduce false positives when detecting solicitations of PII using the trained neural network. In some aspects, the labelled relevant exchanges may be joined with additional metadata, such as a time or call offset within the support call transcript where the relevant exchange occurred, an identification of the agent uttering the specified keyword, and identification of the customer responding to the agent, a call queue, and so on. After extracting and labelling the relevant exchanges, and optionally joining them with additional metadata, the relevant exchanges may be sentence embedded, for example using a universal sentence encoder (USE) or similar. In one example, the USE may encode sentences as a 512 dimensional vector.

In some aspects, the relevant exchanges may be identified using conventional rules-based systems for identifying solicitations of PII. That is, exchanges which may trigger such conventional rules-based systems may flag the relevant exchanges, which may then be labelled as either confirmed or benign, and optionally joined with the additional metadata to form the training data.

In some aspects, while the relevant exchanges may be sentence embedded using a USE, such as a 512 dimensional USE, the additional metadata may be differently encoded. For example, the agent id and customer id may be one-hot encoded, the customer response may be embedded, the call queue may be scaled, and so on. In some aspects, these separately encoded features may be concatenated as input to the neural network.

After generating the training data, in some aspects the training data may be split into multiple data sets, such as a training set, a test set, and a validation set. For example, such a split may be a time-based split or another suitable method for splitting the training set.

As discussed above, the machine learning model 150 may be one or more neural networks, such as one or more feedforward neural networks, such as one or more multilayer perceptron neural networks. The generated training data may be used to train these neural networks to identify solicitations of PII in support call transcripts. More particularly, the neural networks may be trained to generate a PII solicitation risk score for corresponding support call transcripts. For example, as discussed above, different types of PII may require different training data, and consequently training the neural networks for detecting solicitations of each type of PII may be performed separately. The neural networks may be trained using a suitable technique, such as minibatch gradient descent, and may be performed using a suitable loss function, such as a binary cross-entropy loss function. In some aspects, the architecture of the neural network, such as the number and structure of the dense layers of the neural network, may be determined by selecting the smallest (i.e., least computationally costly) model which maximizes the area under the curve (AUC) of the receiver operating characteristic (ROC) for the training set of the training data. Selecting such an architecture may correspond to selecting a least costly architecture which provides the best performance for the training set. In some aspects, selecting the architecture may include selecting the smallest model which has an AUC within a threshold difference of the maximum AUC for the training set.

In addition to training the neural network, the trained neural network may be further processed before deployment. For example, the trained neural network may be regularized, for example using dropout, learning rate, and early stopping. Further, in some aspects, the optimal hyperparameters for the trained neural network may be chosen using a Bayesian hyperparameter search. After processing, the trained neural network may be deployed. For example, the trained neural network may be deployed on the PII solicitation detection system 100 or may be deployed on another suitable computing device coupled to the PII solicitation detection system 100 either directly or via one or more networks.

The deployed neural network may then be used to detect solicitations of PII in input support call transcripts. For example, a support call between an agent and a user may be conducted, and a support call transcript generated for this support call. This support call transcript may be provided to the PII solicitation detection system 100 or to the other computing device where the trained neural network is deployed. Upon receiving the support call transcript, the trained neural network may generate a PII solicitation risk score for the received support call transcript. In some aspects, the PII solicitation risk score may be greater for support call transcripts determined more likely to include solicitations of PII, and lesser for support call transcripts determined to be less likely to include solicitations of PII. In some aspects, if the PII solicitation risk score exceeds a threshold risk score, an alert may be generated. For example, generating an alert may include flagging the support call transcript for further review, for example human review by risk management personnel or similar. In some aspects, generating the alert may further include noting the potential solicitation of PII by the agent participating in the support call, for example in a profile or similar. Further, generating the alert may further include flagging the agent for training in properly securing user privacy during support calls.

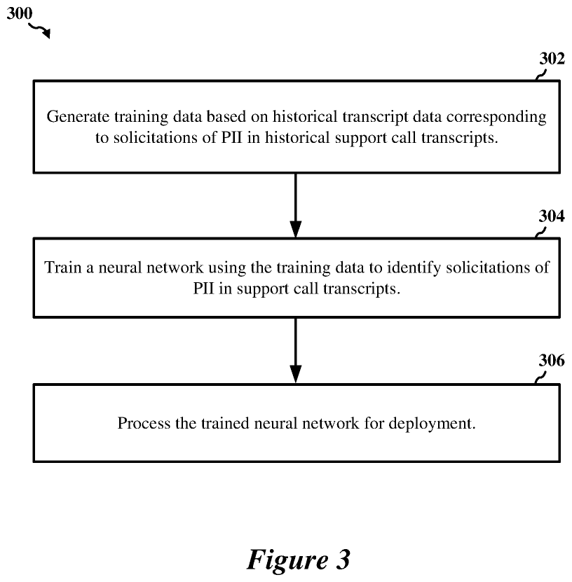

FIG. 3 shows an illustrative flow chart depicting an example operation 300 for identifying solicitations of personally identifiable information (PII), according to some implementations. The example operation 300 may be performed by one or more processors of a computing device, such as the PII solicitation detection system 100 of FIG. 1. It is to be understood that the example operation 300 may be performed by any suitable systems, computers, or servers.

At block 302, the PII solicitation detection system 100 generates training data based on historical transcript data corresponding to solicitations of PII in historical support call transcripts. At block 304, the PII solicitation detection system 100 trains a neural network using the training data to identify solicitations of PII in support call transcripts. At block 306, the PII solicitation detection system 100 processes the trained neural network for deployment.

In some aspects, generating the training data in block 302 may include extracting sentences from the historical transcript data including confirmed solicitations of PII and corresponding responses from the historical transcript data to the sentences including confirmed solicitations of PII. In some aspects generating the training data in block 302 may further include extracting sentences from the historical transcript data including keywords associated with the PII and corresponding responses from the historical transcript data to the sentences including keywords associated with the PII. In some aspects the sentences including the confirmed solicitations of PII may be labelled with a label indicating that the sentences include confirmed solicitations of PII. In some aspects, the extracted sentences including the keywords but not including confirmed solicitations of PII may be labeled with a label indicating that the sentences do not include confirmed solicitations of PII. In some aspects, the extracted sentences and responses may be sentence embedded, for example using a universal sentence encoder.

In some aspects, the PII may be a social security number. In some aspects, the PII may be a credit card number. In some aspects, the PII may be a bank account number. In some aspects, the neural network may be a feedforward neural network, such as a multilayer perceptron.

In some aspects, training the neural network in block 304 is based at least in part on a gradient descent algorithm and a binary cross-entropy loss function. In some aspects, training the neural network in block 304 may include selecting a smallest model architecture which maximizes an area under the curve (AUC) of a receiver operating characteristic (ROC) for the training data. In some aspects, training the neural network in block 304 may include selecting optimal hyperparameters for the neural network based at least in part on a Bayesian hyperparameter search.

In some aspects, processing the trained neural network in block 306 may include regularizing the trained neural network based at least in part on dropout and early stopping.

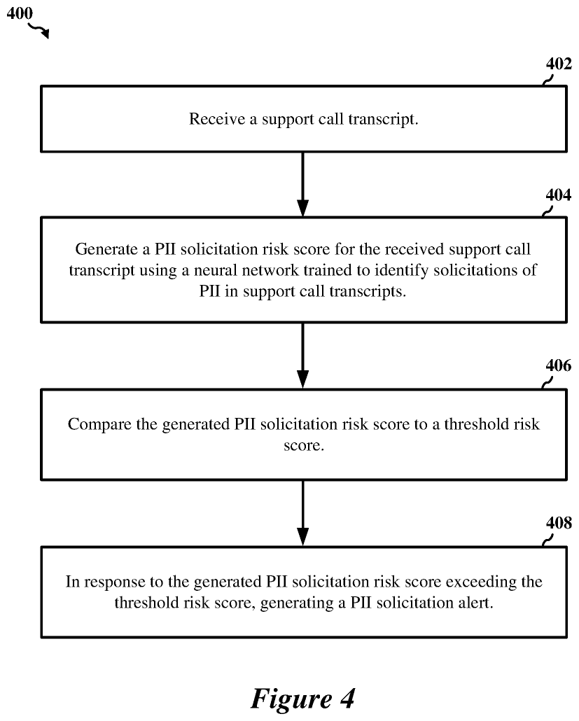

FIG. 4 shows an illustrative flow chart depicting an example operation 400 for identifying solicitations of personally identifiable information (PII), according to some implementations. The example operation 400 may be performed by one or more processors of a computing device, such as the PII solicitation detection system 100 of FIG. 1. It is to be understood that the example operation 400 may be performed by any suitable systems, computers, or servers.

At block 402, the PII solicitation detection system 100 may receive a support call transcript. At block 404, the PII solicitation detection system 100 may generate a PII solicitation risk score for the received support call transcript using a neural network trained to identify solicitations of PII in support call transcripts. At block 406, the PII solicitation detection system 100 may compare the generated PII solicitation risk score to a threshold risk score. At block 408, the PII solicitation detection system 100 may generate a PII solicitation alert in response to the PII solicitation risk score exceeding the threshold risk score.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method of identifying solicitations of personally identifiable information (PII), the method comprising:
generating training data based on historical transcript data corresponding to solicitations of PII in historical support call transcripts;
training a neural network, using the training data, to identify solicitations of PII in support call transcripts; and
processing the trained neural network for deployment.

2. The method of claim 1, further comprising:
receiving a support call transcript;
generating a PII solicitation risk score for the received support call transcript using the trained neural network;
comparing the generated PII solicitation risk score to a threshold risk score; and
in response to the generated PII solicitation risk score exceeding the threshold risk score, generating a PII solicitation alert.

3. The method of claim 1, wherein the PII is a social security number or a credit card number.

4. The method of claim 1, wherein training the neural network is based at least in part on a gradient descent algorithm and a binary cross-entropy loss function.

5. The method of claim 1, wherein the neural network is a feed-forward neural network.

6. The method of claim 5, wherein the neural network is a multilayer perceptron.

7. The method of claim 1, wherein training the neural network comprises selecting a smallest model architecture configured to maximize an area under the curve (AUC) of a receiver operating characteristic (ROC) for the training data.

8. The method of claim 1, wherein processing the trained neural network comprises regularizing the trained neural network based at least in part on dropout and early stopping.

9. The method of claim 1, wherein training the neural network comprises selecting hyperparameters for the neural network based at least in part on Bayesian hyperparameter search.

10. The method of claim 1, wherein generating the training data comprises extracting sentences from the historical transcript data including confirmed solicitations of PII and corresponding responses from the historical transcript data to the sentences including confirmed solicitations of PII.

11. The method of claim 10, further comprising sentence embedding the confirmed solicitations of PII and the corresponding responses.

12. A system for identifying solicitations of personally identifiable information (PII), the system coupled to one or more neural networks and comprising:
one or more processors; and
a memory storing instructions that, when executed by the one or more processors, cause the system to perform operations comprising:
generating training data based on historical transcript data corresponding to solicitations of PII in historical support call transcripts;
training a neural network, using the training data, to identify solicitations of PII in support call transcripts; and
processing the trained neural network for deployment.

13. The system of claim 12, wherein execution of the instructions causes the system to perform operations further comprising:
receiving a support call transcript;
generating a PII solicitation risk score for the received support call transcript using the trained neural network;
comparing the generated PII solicitation risk score to a threshold risk score; and
in response to the generated PII solicitation risk score exceeding the threshold risk score, generating a PII solicitation alert.

14. The system of claim 12, wherein execution of the instructions for training the neural network cause the system to perform operations further comprising training the neural network based at least in part on a gradient descent algorithm and a binary cross-entropy loss function.

15. The system of claim 12, wherein the neural network is a feed-forward neural network or a multilayer perceptron.

16. The system of claim 12, wherein execution of the instructions for training the neural network causes the system to perform operations further comprising selecting a smallest model architecture configured to maximize an area under the curve (AUC) of a receiver operating characteristic (ROC) for the training data.

17. The system of claim 12, wherein execution of the instructions for processing the trained neural network causes the system to perform operations further comprising regularizing the trained neural network based at least in part on dropout and early stopping.

18. The system of claim 12, wherein execution of the instructions for training the neural network causes the system to perform operations further comprising selecting hyperparameters for the neural network based at least in part on Bayesian hyperparameter search.

19. The system of claim 12, wherein generating the training data comprises extracting sentences from the historical transcript data including confirmed solicitations of PII and corresponding responses from the historical transcript data to the sentences including confirmed solicitations of PII.

20. A system for identifying solicitations of personally identifiable information (PII), the system coupled to one or more neural networks and comprising:
one or more processors; and
a memory storing instructions that, when executed by the one or more processors, cause the system to perform operations comprising:
receiving a support call transcript;
generating a PII solicitation risk score for the received support call transcript using a neural network trained to identify solicitations of PII in support call transcripts;
comparing the generated PII solicitation risk score to a threshold risk score; and
in response to the generated PII solicitation risk score exceeding the threshold risk score, generating a PII solicitation alert.
